(19) United States
(12) Patent Application Publication
(10) Pub. No.: US 2009/0254619 A1
(43) Pub. Date: Oct. 8, 2009

(54) STATUS-BASED FILTERED EMAIL ALERTS

(76) Inventors: Nancy E. Kho, Belmont, MA (US); Jane B. Marcus, Westford, MA (US); Shiu F. Poon, Cambridge, MA (US)

Correspondence Address: HOFFMAN WARNICK LLC, 75 STATE STREET, 14TH FLOOR, ALBANY, NY, 12207, US

(21) Appl. No.: 12/061,103

(22) Filed: Apr. 2, 2008

(51) Int. Cl. G06F 15/16

(52) U.S. Cl. 709/206

(57) ABSTRACT

The disclosure is directed to status-based filtered email alerts. A method in accordance with an embodiment includes: obtaining a current availability status of a user; determining whether an email filter is associated with the current availability status of the user, the email filter comprising at least one condition; determining, when an email filter is associated with the current availability status of the user, whether a new email meets each condition of the email filter; and alerting the user of the new email when the new email meets each condition of the email filter.

### BACKGROUND OF THE INVENTION

The present invention relates to electronic mail (email), and more specifically, to status-based filtered email alerts.

### BRIEF SUMMARY OF THE INVENTION

An embodiment of the present invention is directed to a method for providing status-based electronic mail (email) alerts, comprising: obtaining a current availability status of a user; determining whether an email filter is associated with the current availability status of the user, the email filter comprising at least one condition; determining, when an email filter is associated with the current availability status of the user, whether a new email meets each condition of the email filter; and alerting the user of the new email when the new email meets each condition of the email filter.

Another embodiment of the present invention is directed to a system for providing status-based email alerts, comprising: a system for obtaining a current availability status of a user; a system for determining whether an email filter is associated with the current availability status of the user, the email filter comprising at least one condition; a system for determining, when an email filter is associated with the current availability status of the user, whether a new email meets each condition of the email filter; and a system for alerting the user of the new email when the new email meets each condition of the email filter.

Another embodiment of the present invention is directed to a computer program product stored on a computer readable medium, which when executed, provides status-based email alerts, the computer readable medium comprising program code for: obtaining a current availability status of a user; determining whether an email filter is associated with the current availability status of the user, the email filter comprising at least one condition; determining, when an email filter is associated with the current availability status of the user, whether a new email meets each condition of the email filter; and alerting the user of the new email when the new email meets each condition of the email filter.

Another embodiment of the present invention is directed to a method for deploying an application for providing status-based email alerts, comprising: providing a computer infrastructure being operable to: obtain a current availability status of a user; determine whether an email filter is associated with the current availability status of the user, the email filter comprising at least one condition; determine, when an email filter is associated with the current availability status of the user, whether a new email meets each condition of the email filter; and alert the user of the new email when the new email meets each condition of the email filter.

### BRIEF DESCRIPTION OF THE DRAWINGS

These and other features will be more readily understood from the following detailed description of the various aspects of the invention taken in conjunction with the accompanying drawings.

FIG. 1 depicts an illustrative system for providing status-based filtered email alerts in accordance with an embodiment.

FIG. 2 depicts a flow diagram of an illustrative process for providing status-based filtered email alerts in accordance with an embodiment.

FIG. 3 depicts an illustrative user interface (UI) for defining/editing an email filter in accordance with an embodiment.

FIG. 4 depicts an illustrative environment for providing status-based filtered email alerts in accordance with an embodiment.

### DETAILED DESCRIPTION OF THE INVENTION

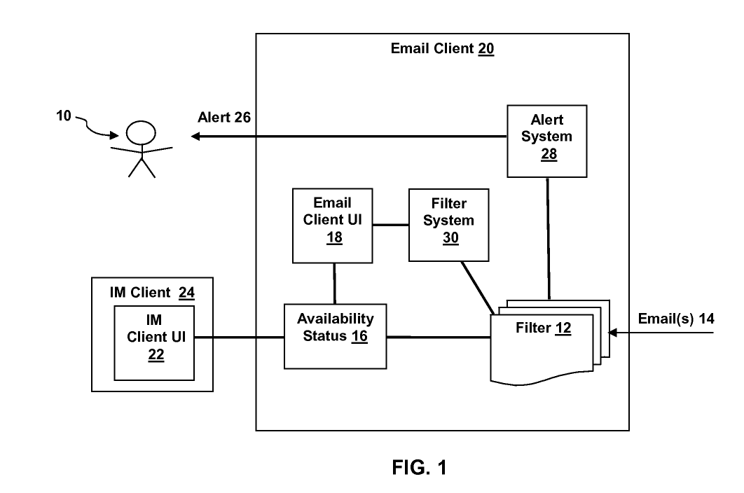

FIG. 1 depicts an illustrative system for providing status-based filtered email alerts. Using this system, a user 10 can define one or more email filters 12 for filtering emails 14 based on the availability status 16 of the user 10. The availability status 16 can be set by the user 10 in numerous ways, including, for example, via a user interface (UI) 18 of an email client 20, via a UI 22 of an instant messaging (IM) client 24, via a UI of a computer operating system (OS), etc. The email client 20 and IM client 24 may be provided in a single integrated application.

As an example, if the user 10 is very busy, the user 10 may wish to be notified automatically via an alert 26 generated by an alert system 28 only when very important emails 14 are received by the email client 20. If, however, the user 10 is not busy, the user 10 may wish to be notified automatically via an alert 26 whenever any email 14 is received. The alert 26 may comprise, for example, a pop-up window, the display of an icon, the playing of a sound, etc.

The user 10 can define or edit an email filter 12, and can selectively associate the email filter 12 with, an availability status 16, using filter system 30. The email client 20 checks for email 14 periodically as configured (e.g., once a minute, once an hour, etc.), but only alerts the user 10 if a received email 14 meets the condition(s) of an email filter 12 associated with the current availability status 16 of the user 10. For example, a user 10, who has set their availability status 16 as “very busy”, will only be alerted of emails 14 that meet the filtering criteria of an email filter 12 associated with the “very busy” availability status 16. In this case, the user 10 will not be alerted to the receipt of unimportant or spam email 14, thereby decreasing the number of undesired interruptions and increasing user productivity.

In general, a user 10 who has set their availability status 16 to a particular level will only be alerted of emails 14 that meet the filtering criteria of an email filter 12 associated with that availability status 16. When the user 10 changes their availability status 16, an email filter 12 (if any) associated with the new availability status 16 is used. If a particular availability status 16 is not associated with an email filter 12, filtering of emails 14 based on that availability status 16 is not performed. As such, the user 10 will be alerted of all new emails 14. Alternatively, the user 10 can set a default level of filtering that will be applied if a particular availability status 16 is not associated with an email filter 12.

When the user 10 defines a new email filter 12 (or any time thereafter), the user 10 can associate the email filter 12 with an availability status 16. For example, the user 10 may have the following status levels: “very busy”; “busy”, and “normal”. For each availability status 16, the user 10 can define any number of email filters 12 (all/any of which can be enabled at any given time). For example, the user 10 may configure the following email filters 12: “very busy”—emails 14 are filtered such that alerts 26 are generated only for those emails 14 sent by a particular person (e.g., an important client, a manager, etc.) or related to a particular project; “busy”—emails 14 are filtered such that alerts 26 are generated only for those emails 14 sent by a manager or team members of the user 10; and “normal”—emails 14 are filtered such that alerts 26 are generated for any email 14 that has not been tagged as spam by the email client 20.

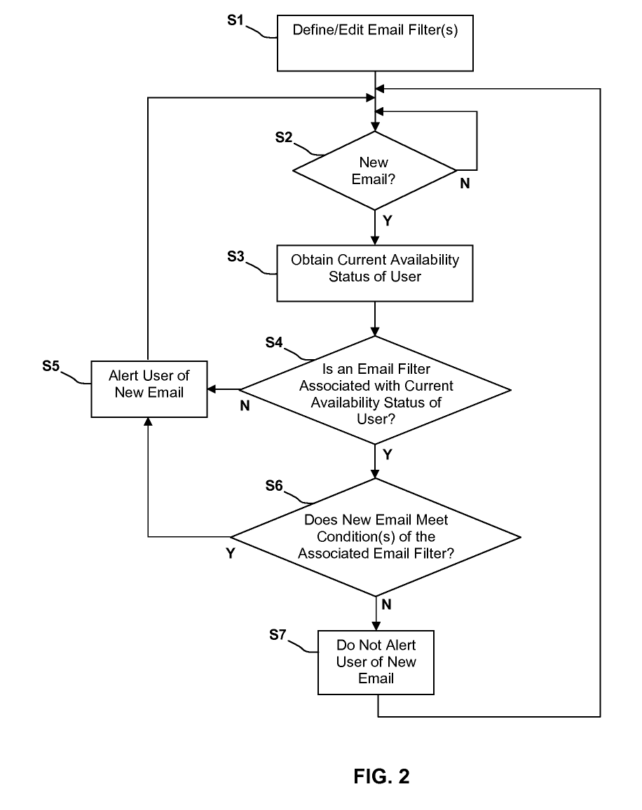

A flow diagram of an illustrative process in accordance with an embodiment, described below with reference to the illustrative system of FIG. 1, is depicted in FIG. 2. At S1, the user 10 defines a new email filter(s) 12 or edits an existing email filter(s) 12 using the filter system 30. At S2, the email client 20 periodically checks for new emails 14. When a new email 14 is received by the email client 20 (YES, S2), the email client 20 obtains the current availability status 16 of the user 10 at S3. At S4, the email client 20 determines whether an email filter 12 is associated with the current availability status 16 of the user 10. If no (NO, S4), the user 10 is alerted at S5 of the new email 14 by the alert system 28.

If at least one email filter 12 is associated with the current availability status 16 of the user 10 (YES, S4), the email client 20 determines at S6 whether the new email 14 meets the condition(s) of any of the associated email filters 12. If the new email 14 does not meet the condition(s) of any of the associated email filters 12 (NO, S6), the email client 20 does not generate an alert 26 informing the user 10 that the new email 14 has arrived (S7). Flow then passes back to S2. If, however, the new email 14 does meet the condition(s) of any of the associated email filters 12 (YES, S6), the email client 20 generates an alert 26 in S5, via the alert system 28, informing the user 10 that the new email 14 has arrived. Flow then passes back to S2. At any time in the above-described process, the user 10 can define new email filter(s) 12 or edits existing email filter(s) 12 using the filter system 30 (S1).

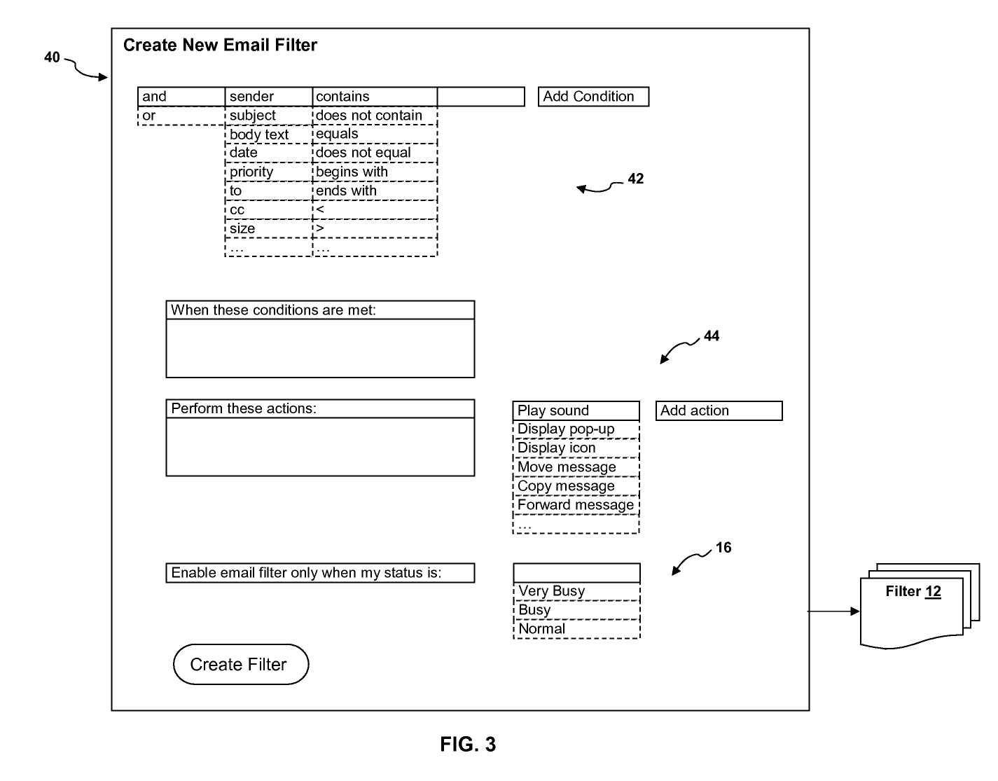

An illustrative user interface (UI) 40 for defining/editing an email filter 12 in accordance with an embodiment is depicted in FIG. 3. Using the UI 40, a user can define: the condition(s) 42 under which an alert 26 (FIG. 1) is to be generated (e.g., subject of email contains the phrase “Project X”, sender of email is user's manager, etc.); the type of action 44 (e.g., alert 26) to be performed/generated (e.g., play sound, display pop-up, etc.); and an associated availability status 16 (if any). As shown, a default set of availability statuses 16 can be provided, including, for example, “Very busy”, “Busy”, and “Normal”. In another embodiment, a user can define his/her own set of availability status levels 16 or edit an existing set of availability status levels 16. In yet another embodiment, the UI 40 can be configured to perform actions 44 other than or in addition to the generation of alerts 26. Such actions 44 can include, for example, moving/copying an email to a specific folder, forwarding an email to another user, and/or the like.

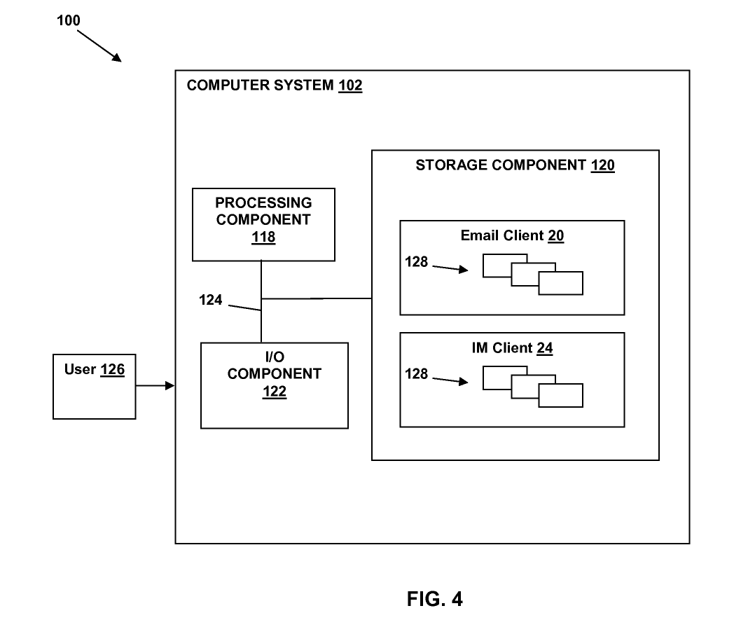

FIG. 4 shows an illustrative environment 100 for providing status-based filtered email alerts in accordance with any/all embodiments of the disclosure. To this extent, environment 100 includes a computer system 102 that can perform the processes described herein.

The computer system 102 is shown including a processing component 118 (e.g., one or more processors), a storage component 120 (e.g., a storage hierarchy), an input/output (I/O) component 122 (e.g., one or more I/O interfaces and/or devices), and a communications pathway 124. In general, the processing component 118 executes program code, such as email client 20 and IM client 24, which are at least partially stored in storage component 120. While executing program code, the processing component 118 can read and/or write data to/from the storage component 120 and/or the I/O component 122. The communication pathway 124 provides a communications link between each of the components in computer system 102. The I/O component 122 can comprise one or more human I/O devices, which enable a human user 126 to interact with the computer system 102, and/or one or more communications devices to enable other computer system(s) to communicate with the computer system 102 using any type of communications link.

The computer system 102 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the email client 20 and IM client 24 can be embodied as any combination of system software and/or application software. Further, email client 20 and IM client 24 can each be implemented using a set of modules 128. In this case, a module 128 can comprise a component that performs a set of actions used by the email client 20 and/or IM client 24. Further, it is understood that some of the actions discussed herein may not be implemented or additional actions may be implemented by computer system 102.

When the computer system 102 comprises multiple computing devices, each computing device can have only a portion of the email client 20 and/or IM client 24 installed thereon (e.g., one or more modules 128). However, it is understood that the computer system 102 is only representative of various possible equivalent computer systems that may implement the process described herein. To this extent, in other embodiments, the actions implemented by the computer system 102 can be at least partially implemented by one or more computing devices that include any combination of general and/or specific purpose hardware and/or program code. In each embodiment, the program code and hardware can be provided using standard programming and engineering techniques, respectively.

When the computer system 102 includes multiple computing devices, the computing devices can communicate over any type of communications link. Further, while performing the process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

It is understood that each of the process flows shown and described herein are only illustrative. To this extent, numerous variations of these process flows are possible, and are included within the scope of this disclosure. Illustrative variations include performing one or more processes in parallel and/or a different order, performing additional processes, not performing some processes, and/or the like. To this extent, multiple tasks/threads/processes can be used to perform the actions of the processes described herein.

It is further understood that aspects of the invention further provide various alternative embodiments. For example, in one embodiment, the invention provides a computer program stored on at least one computer-readable medium, which when executed, enables a computer system to perform the processes described above. To this extent, the computer-readable medium can include program code for implementing some or all of the process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; a modulated data signal having one or more of its characteristics set and/or changed in such a manner as to encode information in the signal; paper; and/or the like.

In another embodiment, a computer system, such as the computer system 102, can be obtained (e.g., provided, created, maintained, made available, etc.) and one or more programs/systems for performing the process described herein can be obtained (e.g., provided, created, purchased, used, modified, etc.) and deployed to the computer system. To this extent, the deployment can comprise one or more of: (1) installing program code on a computing device from a computer-readable medium; (2) adding one or more computing devices to the computer system; and (3) incorporating and/or modifying the computer system to enable it to perform the process described herein.

Aspects of the invention can be also implemented as part of a business method that performs the process described herein on a subscription, advertising, and/or fee basis. That is, a service provider could offer to provide some/all of the components/processes needed to provide status-based filtered email alerts, as described herein. In this case, the service provider can manage (e.g., create, maintain, support, etc.) some or all of the environment 100, such as the computer system 102, that performs the process described herein for one or more customers. In return, the service provider can receive payment from the customer(s) under a subscription and/or fee agreement, receive payment from the sale of advertising to one or more third parties, and/or the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing status-based electronic mail (email) alerts, comprising:
obtaining a current availability status of a user;
determining whether an email filter is associated with the current availability status of the user, the email filter comprising at least one condition;
determining, when an email filter is associated with the current availability status of the user, whether a new email meets each condition of the email filter; and
alerting the user of the new email when the new email meets each condition of the email filter.

2. The method of claim 1, further comprising:
obtaining the current availability status of the user upon receipt of the new email.

3. The method of claim 1, further comprising:
not alerting the user of the new email when the new email does not meet each condition of the email filter.

4. The method of claim 1, further comprising:
alerting the user of the new email when an email filter is not associated with the current availability status of the user.

5. The method of claim 1, further comprising:
defining or editing an email filter via a user interface (UI).

6. The method of claim 1, further comprising:
setting the current availability status of the user via a UI.

7. A system for providing status-based electronic mail (email) alerts, comprising:
a system for obtaining a current availability status of a user;
a system for determining whether an email filter is associated with the current availability status of the user, the email filter comprising at least one condition;
a system for determining, when an email filter is associated with the current availability status of the user, whether a new email meets each condition of the email filter; and
a system for alerting the user of the new email when the new email meets each condition of the email filter.

8. The system of claim 7, further comprising:
a system for obtaining the current availability status of the user upon receipt of the new email.

9. The system of claim 7, wherein the user is not alerted of the new email when the new email does not meet each condition of the email filter.

10. The system of claim 7, further comprising:
a system for alerting the user of the new email when an email filter is not associated with the current availability status of the user.

11. The system of claim 7, further comprising:
a system for defining or editing an email filter via a user interface (UI).

12. The system of claim 7, further comprising:
a system for setting the current availability status of the user via a UI.

13. A computer program product stored on a computer readable medium, which when executed, provides status-based electronic mail (email) alerts, the computer readable medium comprising program code for:
obtaining a current availability status of a user;
determining whether an email filter is associated with the current availability status of the user, the email filter comprising at least one condition;
determining, when an email filter is associated with the current availability status of the user, whether a new email meets each condition of the email filter; and
alerting the user of the new email when the new email meets each condition of the email filter.

14. The program product of claim 13, further comprising program code for:
obtaining the current availability status of the user upon receipt of the new email.

15. The program product of claim 13, further comprising program code for:
not alerting the user of the new email when the new email does not meet each condition of the email filter.

16. The program product of claim 13, further comprising program code for:
alerting the user of the new email when an email filter is not associated with the current availability status of the user.

17. The program product of claim 13, further comprising program code for:
defining or editing an email filter via a user interface (UI).

18. The program product of claim 13, further comprising program code for:
setting the current availability status of the user via a UI.

19. A method for deploying an application for providing status-based electronic mail (email) alerts, comprising:
providing a computer infrastructure being operable to:
obtain a current availability status of a user;
determine whether an email filter is associated with the current availability status of the user, the email filter comprising at least one condition;
determine, when an email filter is associated with the current availability status of the user, whether a new email meets each condition of the email filter; and
alert the user of the new email when the new email meets each condition of the email filter.
